(19) United States
(12) Patent Application Publication
(10) Pub. No.: US 2018/0373305 A1
(43) Pub. Date: Dec. 27, 2018

(54) POWER CONSUMPTION TIME SYNCHRONIZATION

(71) Applicant: Sony Mobile Communications Inc., Tokyo (JP)

(72) Inventors: Kåre AGARDH, Rydebäck (SE); Vanja PLICANIC SAMUELSSON, Lund (SE); Gunnar KLINGHULT, Lund (SE); Joachim HOLST, Vollsjö (SE); Valentyn SHEVCHENKO, Lund (SE)

(21) Appl. No.: 16/065,088

(22) PCT Filed: Dec. 12, 2016
(86) PCT No.: PCT/EP2016/080586

§ 371 Date: Jun. 21, 2018

(30) Foreign Application Priority Data
Dec. 22, 2015 (EP) 15201882.6

(51) Int. Cl. G06F 1/32; G06F 11/30; G06F 11/34

(52) U.S. Cl. CPC G06F 1/3206; G06F 11/3062; G06F 2201/86; G06F 11/3419; G06F 2201/865; G06F 11/3476

(57) ABSTRACT

Indicators of a global timing reference (133) are received. Indicators of a time-resolved power consumption (131) of a device (110) are received. The device (110) executes software code. The execution of the software code and the power consumption (131) are referenced to the global timing reference (133) when creating a power log. The power log may be output to a user or stored in a memory according to various embodiments.

### TECHNICAL FIELD

Various embodiments relate to a method comprising referencing execution of software code and power consumption of a device to a global timing reference when creating a power log, and to a corresponding entity.

### BACKGROUND

Energy consumption/power consumption is a critical part of product design. In particular, in the Internet of Things (IoT) domain, it is expected that more and more connected devices (terminals) will become battery operated. E.g., it is expected that within a few years, up to 50 billion devices will be connected to the Internet globally. Here, a significant fraction will have a battery energy supply.

Reduced power consumption is critical for battery-operated devices in order to reduce maintenance efforts by users and facilitate prolonged charging cycles. Also, for devices connected to a main supply that are non-battery-operated, a reduction of the power consumption is desirable. In particular, in terms of environmental protection and reduction of operating costs, a limited power consumption is generally favorable.

Where devices execute software code it is sometimes difficult to link the power consumption to certain elements of the software code to identify reasons for increased power consumption during development of a product. Usually, expensive measurement equipment is required as well as detailed experience and expertise in solving specific problems to make tailored optimizations.

### SUMMARY

Accordingly, a need exists for solutions that are smart and efficient in supporting and guiding developers to improve design of software code causing reduced power consumption.

This need is met by the features of the independent claims. The dependent claims define embodiments.

According to various embodiments, a method is provided. The method comprises receiving indicators of a global timing reference. The method further comprises receiving indicators of a time-resolve power consumption of a device. The device executes software code. The method further comprises referencing the execution of the software code, and the power consumption to the global timing reference when creating a power log.

According to various embodiments, an entity is provided. The entity comprises a memory. The memory is configured to store program code executable by at least one processor. The at least one processor is coupled with a memory and configured to perform the following steps upon execution of the program code: receiving indicators of a global timing reference; and receiving indicators of a time-resolved power consumption of a device executing software code; and referencing the execution of the software code and the power consumption to the global timing reference when creating a power log.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 is a schematic illustration of a device executing software code and consuming power when executing the software code, wherein FIG. 1 further schematically illustrates a time server providing a global timing reference.

FIG. 2 schematically illustrates referencing execution of the software code and the power consumption to the global timing reference when creating a power log.

FIG. 3 schematically illustrates an event log of the execution of the software code, wherein the event log comprises application events of an application implemented by the software code, as well as machine events of a processor of the device executing the software code.

FIG. 4 schematically illustrates the application events of the event log in greater detail.

FIG. 5 schematically illustrates the power log comprising references between the execution of the software code and the power consumption, and the global timing reference, respectively.

FIG. 6 schematically illustrates a first device executing software code and a second device executing software code, wherein the first device is a terminal connected via a radio link with an access node of a cellular network, wherein the second device is the access node.

FIG. 7 schematically illustrates an entity comprising a memory and at least one processor, wherein the at least one processor is configured to perform steps of creating a power log when executing program code stored in the memory.

FIG. 8 is a flowchart of a method according to various embodiments.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, various example embodiments are illustrated with reference to the accompanying drawings. In particular, hereinafter, techniques of creating a power log are explained. The power log references execution of software code and power consumption of a device executing the software code with a global timing reference.

In some examples, the power log may be written to a memory, e.g., a non-volatile memory. In some examples, the power log may be—directly or indirectly—output to a user; thereby, debugging operation is facilitated.

The global timing reference may be device independent. I.e., it is possible that the global timing reference is independent of the execution of the software code. E.g., the global timing reference may be received from a server different than the device. E.g., the global timing reference may be received according to the Network Time Protocol or the Precision Time Protocol. The global timing reference may specify a current time in human-understandable format, i.e., as a real time clock.

By using the global timing reference, a flexible solution is provided which enables support of creating power logs for various types and kinds of devices. The power logs may be presented to users. E.g., if compared to implementations where a local timing reference—which may be dependent on the device that is used—is used, support of various systems, including heterogeneous systems comprising different numbers of Central Processing Units (CPU) cores, etc., can be facilitated.

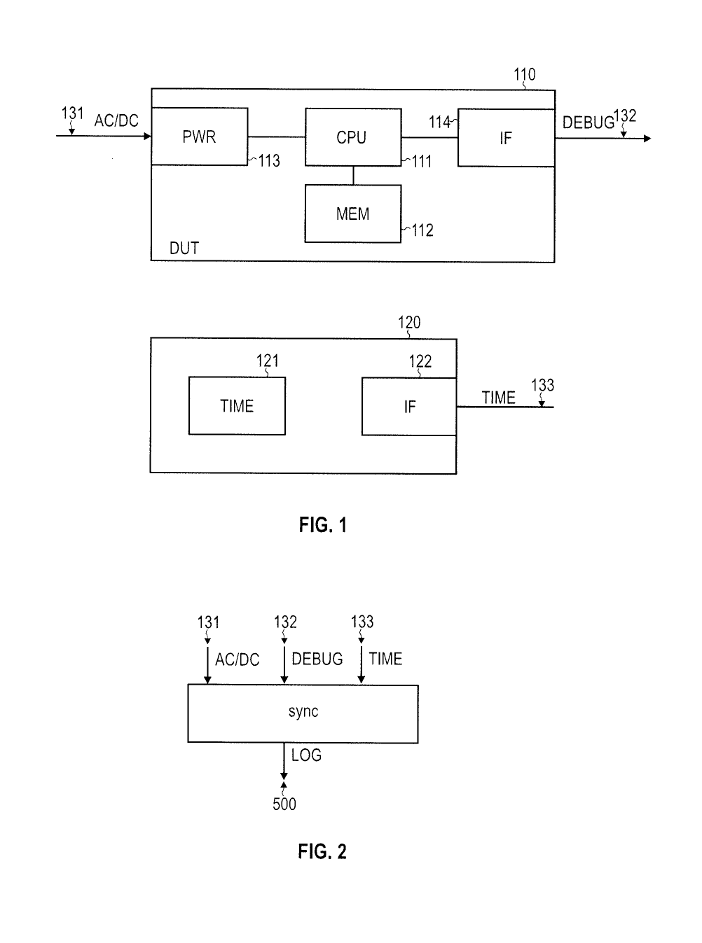

With respect to FIG. 1, aspects of a device 110 executing software code and a network server 120 providing indicators of a global timing reference 133 are illustrated. The device 110 comprises a processor 111, e.g., a single core CPU or a multicore CPU. The processor 111 is coupled with a memory 112, e.g., a non-volatile memory. The memory 112 may store software code that can be executed by the processor 111. The software code may be a multi-core and/or a multi-thread software code, e.g., depending on the architecture of the processor 111.

E.g., execution of the software code can cause the processor 111 executing one or more applications. The applications may provide services to a user, e.g., via a human machine interface (HMI) of the device 110 (not shown in FIG. 1). The applications may comprise control of hardware periphery of the device 110, e.g., comprising elements selected from the group comprising: the HMI, a wireless transceiver for communicating on a radio link, data storage, etc. E.g., the HMI may comprise elements selected from a group comprising: a light emitting diode (LED), a speech interface, a display, a touch-sensitive display, a mouse, a trackball, a keyboard, etc. The application may also comprise execution of data operations and/or calculations. Various tasks as outlined above may be executed serially and/or in parallel over the course of time by the application. This may cause a time-variable power consumption of the device 110.

With a changing number and type of tasks executed by the application implemented by the software code, the power consumption of the device 110 can change over the course of time. The device 110 comprises a power supply 113 which receives power 131, e.g., by means of an AC or DC current. E.g., the power supply 113 can receive the current 131 from a battery or a mains supply comprising, e.g., a transformer (all not shown in FIG. 1). The current can be indicative of the power consumption of the device 110, e.g., in combination with an operating voltage.

It is possible to receive respective indicators of the time-resolved power consumption 131 of the device 110. E.g., a mains supply or the battery may provide the indicators via a respective control interface. In other examples, on-chip diagnostics implemented with a device 110 can be employed, alternatively or additionally. In still further examples, a respective amperemeter or voltmeter may be provided within the signal path feeding the power supply 113, alternatively or additionally. The indicators may comprise time samples specifying the power consumption explicitly or implicitly for certain points in time; the points in time may be identified by timestamps in a local timing reference of the device or the measurement equipment and/or a known sampling rate. A sampling rate of the indicators of the power consumption 131 may be fixed or may change over the course of time.

The device 110 also comprises a control interface 114. The control interface 114 is configured to output an event log of the execution of the software code. The event log may highlight certain events or tasks performed by the processor 111 when executing the software code. As such, the event log 132 may be indicative of said executing of the software code. Events of the event log may be associated with timestamps of a local timing reference; such associations may be achieved by tagging the events with timestamps of a local timing reference and/or using a communication protocol for providing the event log which is time calibrated. E.g., the timestamps may be derived from CPU clock cycles based on e.g., a CPU clock frequency of the processor 111. The control interface 114 may operate according to different communication protocols, e.g., UART or TCP/IP.

Now referring to the network server 120 providing the indicators of the global timing reference 133: the network server 120 comprises a clock 121 generating the global timing reference. E.g., the clock 121 may be a local clock of the network server 120 or may be synchronized with a standardized reference clock, e.g., operating based on an atomic clock. E.g., the global timing reference provided by the clock 121 can be a real time clock; the real time clock may count time in units understandable by humans.

Via a respective interface 122, the network server 120 is configured to output the indicators of the global timing reference 133. The indicators of the global timing reference 133 can use different formats in different examples. E.g., in some examples, the indicators of the global timing reference 133 are in the format of Internet time, i.e., “hours:minutes:seconds:milliseconds” where each field has, e.g., a two digit precision. The interface 122 may operate according to different communication protocols, e.g., UART or TCP/IP.

From FIG. 1 it is apparent that the global timing reference 133 provided by the network server 120 can be independent of the device 110, in particular independent of executing of the software code by the processor 111.

FIG. 2 illustrates aspects of referencing the execution of the software code and the power consumption to the global timing reference 133 when creating a power log 500. As illustrated schematically by FIG. 2, the indicators of the time-resolved power consumption 133, the event log 132, and the indicators of the global timing reference 133 are all fed into a synchronization function implementing said referencing. The power log 500 is output from the synchronization function.

The power log 500 may then be stored or output to a user. As such, in some examples the synchronization function may be part of rendering an output view of the power log 500 presented to a user. Generally, the synchronization function may be implemented as software code executed by a processor or may be implemented at least partly in hardware.

The synchronization function as illustrated schematically by FIG. 2 may perform different tasks. E.g., it is possible that the synchronization function maps a local timing reference (not shown in FIG. 2) associated with the indicators of the time-resolved power consumption 131 and/or associated with the event log 132 with the global timing reference 133. As such, it is possible that said referencing of the execution of the software code and the power consumption to the global timing reference 133 is based on a local timing reference of the device 110.

Alternatively or additionally, the synchronization function may perform interpolation of sampling points for which indicators of the time-resolved power consumption 131 and/or for which entries of the event log 132 are available in order to facilitate said referencing to the global timing reference 133.

Alternatively or additionally, the synchronization function can implement one or more filters for filtering out undesired data from the indicators of the time-resolved power consumption 131 and/or the event log 132.

As disclosed above, in some examples, it is possible that the various events of the event log are associated with the local timing reference of the device 110. Here, details of referencing the event log to the global timing reference are explained. Said referencing of the execution of the software code to the global timing reference 133 may comprise mapping the local timing reference to the global timing reference 133. For such techniques of mapping the local timing reference to the global timing reference 133, different techniques are conceivable.

Mapping may comprise manually aligning a zero timestamp with the respective timestamp of the global timing reference 133. As such, said referencing may be based on the zero timestamp. The zero timestamp may mark initiation of executing said software code or creating of the event log. Alternatively or additionally, the zero timestamp may relate to the point in time of executing of a characteristic event which may be easily identified in the event log.

Said referencing may be further based on incremental time intervals relative to the zero timestamp. E.g., delta times to the zero timestamp may be deduced by relying on fixed, predefined time intervals for which the event log provides events. Delta times to the zero time stamp may also be deduced by relying on relative time differences of timestamps associated with the events in the event log, irrespective of the fact that the timestamps may be defined in a local timing reference of the device 110.

In further scenarios, it is also possible that the event log 132, 132-1, 132-2 is received via a communication protocol implementing a sequence of incremental transmission time intervals. In particular, the transmission time intervals may be of fixed length. An example may be the Universal Asynchronous Receiver Transmitter (UART) protocol. Such a UART protocol may implement serial communication interfaces, e.g., according to RS-232. Then, where a reference timestamp such as the zero timestamp is mapped to the global timing reference, timestamps of the further events may be readily deduced by considering the fixed length of the incremental transmission time intervals with respect to the reference timestamp as the delta time.

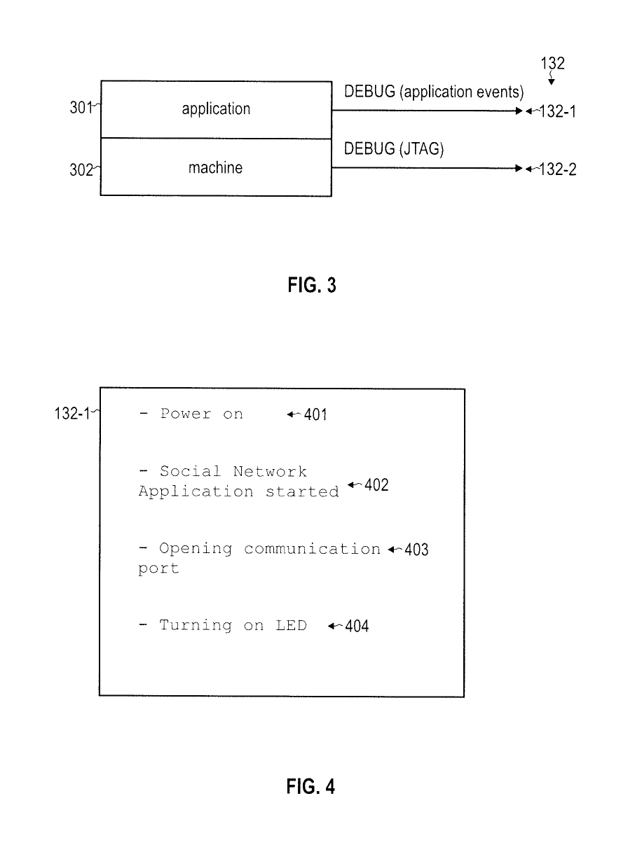

FIG. 3 illustrates aspects of the event log 132, 132-1, 132-2 in greater detail. In particular, as illustrated in FIG. 3, the event log 132 can comprise different levels of abstraction and/or granularity.

E.g., the event log 132 can comprise a high-level log 132-1 comprising application events of an application 301 implemented by the software code. Application events may be events which influence the behavior of the device 110 as perceivable by a user of the device 110.

Alternatively or additionally, the event log 132 can comprise a low-level log 132-2 comprising machine events of a machine layer 302 of the device 110 which is executing the software code. E.g., the machine layer 302 can be implemented by the processor 111. E.g., the machine layer 302 can implement low-level machine events such as Boolean operations, numerical operations, cache read/write operations, etc. E.g., in some examples it is possible that the low-layer event log 132-2 is implemented in the Joint Test Action Group (JTAG) according to the Institute of Electrical and Electronics Engineers (IEEE) standard 1149.1.

Thus, as will be appreciated from the above, the different logs 132-1, 132-2 may implement different levels of abstraction; i.e., while the JTAG-based low-level event log 132-2 indicates what happens on a low level of the machine code, it may not be easily deducible why respective events of the low-level event log 132-2 occurred from a perspective of the user; such information may, on the other hand, be readily deducible from the high-level application-based event log 132-1.

FIG. 4 schematically illustrates aspects of the high-level event log 132-1 comprising application events 401-404 of an application 301 implemented by the software code. As illustrated by FIG. 4, the corresponding events are abstract of the lower level machine events and relate to, e.g.: power on 401, social network application started 402, opening communication port 403, and turning on LED 404. Such events have an impact on the user experience.

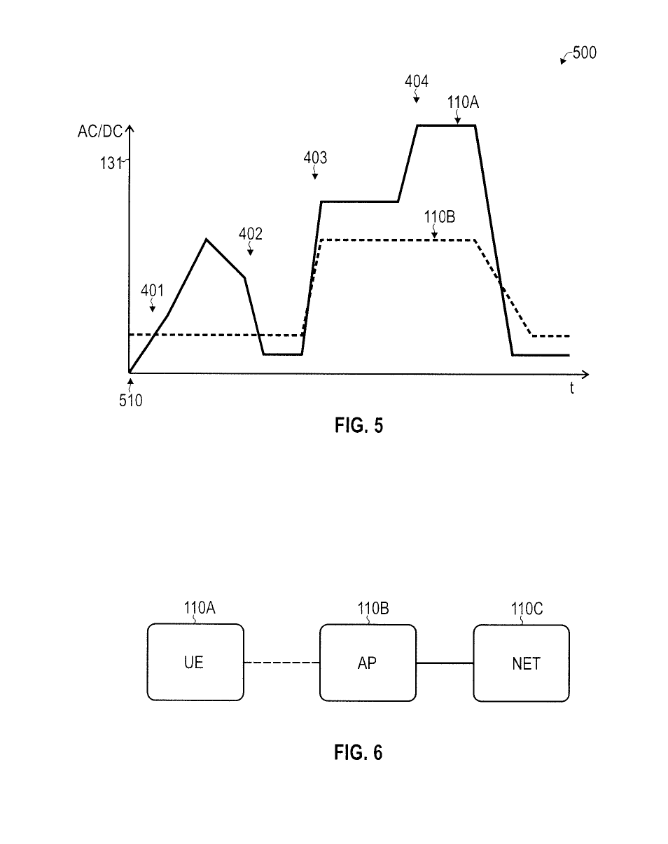

FIG. 5 illustrates aspects of the power log 500. FIG. 5 is a graphical representation of the power log 500. In other examples, instead of providing a graphical representation of the power log 500, a text representation or a mixed text/graphics representation of the power log 500 may be provided. The power log 500 may be output to a user or may be stored in a memory as a file.

The power log 500 can comprise references between the power consumption 131 and the execution of the software code of multiple devices. In the example of FIG. 5, the power log 500 of FIG. 5 illustrates the power consumption 131 as a function of time for a first device 110A (full line in FIG. 5) and a second device 1108 (dashed line in FIG. 5).

The events 401-404 of the power log 500 are associated with both devices 110A, 1108. As such, the power consumptions 131 and the event logs 132, 132-1, 132-2 of the execution of the software code by each one of the devices 110A, 1108 are referenced to the global timing reference 133 when creating the power log 500; in the example of FIG. 5, said referencing is based on a zero timestamp 510 corresponding to the beginning of the event logs 132, 132-1, 132-2 of the execution of the software code by each one of the devices 110A, 1108. However, in other examples other techniques of said referencing as disclosed above may be used.

As can be seen from FIG. 5, the power log 500 indicates that the power consumption 132 varies over the course of time. In particular, in response to the events 401-404, characteristic changes in the power consumption 131 are observed. Such changes in the power consumption 131 as indicated by the power log 500 can be used in order to tailor the software code in order to achieve an overall reduced power consumption of the applications implemented by the software code.

As can be seen from FIG. 5, the power consumptions 131 of the first and second devices 110A, 1108 are synchronized. This may be because the software code executed by the first and second devices 110A, 1108 implement two time-coherent applications. E.g., the applications executed by the devices 110A, 1108 may implement communication with one another.

FIG. 6 illustrates aspects of the devices 110A, 1108. In the example of FIG. 6, the first device 110A is a terminal attached via a radio link to an access node 1108 of a wireless network 110C. The second device is the access node 1108. In further examples, it is also possible that the power log 500 is created for one more nodes of the (core) of the wireless network 110C.

As can be seen from FIGS. 5 and 6, it is possible that the power log 500 is created by referencing the execution of the software code of the first device 110A, the power consumption 131 of the first device 110A, the execution of the software code of the second device 1108, the power consumption 131 of the second device 1108 all to the global timing reference 133. Such creation of the power log 500 comprising information on multiple devices 110, 110A, 1108, 110C is facilitated by the global timing reference 133. In particular, if compared to scenarios where a local timing reference of one of the devices 110, 110A, 1108, 110C is used, it is possible to implement said referencing independent of particular properties of the low-level machine events influencing the local timing reference. Where the global timing reference 133 is used, interoperability between the multiple devices 110, 110A, 1108, 110C is ensured. Local timing references may be program counter specific and maybe influenced, e.g., by execution of a multi-core and/or a multi-thread software code on different machines. Time differences arising from such device-specific properties can be avoided when relying on the global timing reference 133. Further, by relying on the global timing reference 133, control signaling otherwise required for synchronizing the local timing references of the involved devices 110, 110A, 1108, 110C can be reduced; thereby, inaccuracies in the time-resolved power consumption 131 arising from such control signaling for synchronization can be reduced.

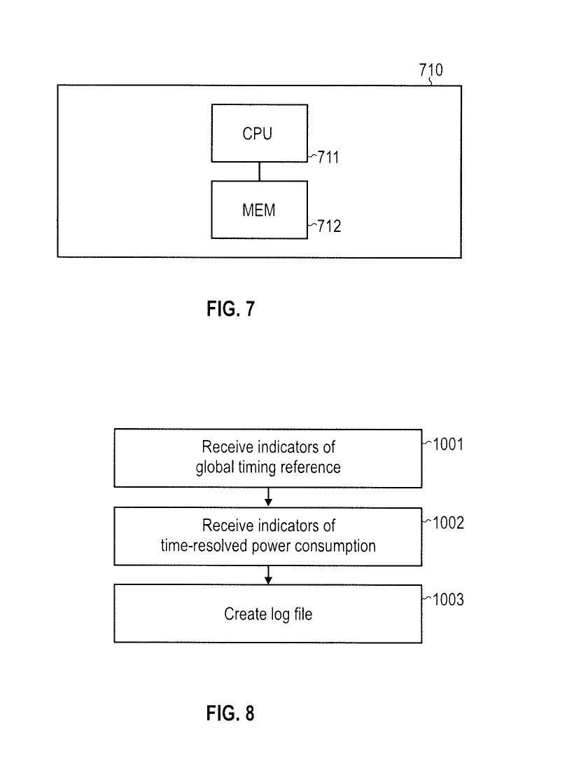

FIG. 7 illustrates aspects with respect to an entity 710 configured to implement techniques for creating the power log 500 as explained herein. The entity 710 comprises a processor 711 and a memory 712. The entity 710 may further comprise a Human Machine Interface (HMI) (not shown in FIG. 7); via the HMI, the entity 710 may output the power log 500 to a user. E.g., the HMI may comprise elements selected from the group comprising: a voice interface; a graphical interface; a display; a mouse; a keyboard; a trackball; a touchscreen.

The memory 712 is configured to store program code that can be executed by the processor 711. The processor 711 is coupled with a memory 712 and is configured to perform techniques as illustrated herein with reference to creating the power log 500.

E.g., when the processor 711 executes the program code stored in the memory 712, this may cause execution of the method as illustrated by the flowchart of FIG. 8.

First, at 1001, the indicators of the global timing reference 133 are received, e.g., via the Network Time Protocol or the Precision Time Protocol. The global timing reference 133 may be a real time clock, i.e., specifying the current time in human-understandable format. The global timing reference 133 may be device-independent, i.e., independent of clock cycles of the devices 110, 110A, 1108, 110C.

In some examples, the method may further comprise determining indicators of the global timing reference 133. Here, e.g., a respective time network server may be involved.

Next, at 1002, the indicators of the time-resolved power consumption 131 are received. At 1002, indicators for the power consumption of each logged device 110, 110A, 1108, 110C may be received.

In some examples. the method may further comprise determining the indicators of the time-resolved power consumption 131. Here, e.g., respective measurement equipment may be involved.

It is possible that the indicators are received at 1002 via a communication protocol implementing a sequence of incremental transmission time intervals; e.g., the power consumption 131 may be sampled at corresponding fixed time intervals. Then, it is possible to synchronize the power consumption 131 with the global timing reference 133 based on the zero timestamp 510 and incremental time intervals relative to the zero timestamp 510 here corresponding to the transmission time intervals. In other examples, it is possible that the indicators of the power consumption 131 already include timestamps, e.g., in a local timing reference. Here, the local timing reference may be synchronized with the global timing reference which may be, again, based on a zero timestamp 510.

At 1003, the power log 500 is created. For this, the execution of the software code is referenced to the global timing reference 133; further, the power consumption 131 is referenced to the global timing reference 133 as explained above.

The execution of the software code may be characterized in different examples by different properties. E.g., in some examples, the execution of the software code may be characterized by the event log 132, 132-1, 132-2, e.g., comprising application events 401-404 of an application 301 implemented by the software code and/or comprising machine events of at least one processor 111 of the device 110, 110A, 110B, 110C executing the software code. In further examples, the execution of the software code may be characterized by payload data output of the software code, communication messages output by the software code, read/write operations executed by the software code, operational states of periphery of the device 110, 110A, 110B, 110C controlled by the software code, etc. Such properties may be externally sampled or tested such that the software code itself is not required to provide debug functionality for providing the event log at least in some examples. In some examples, the method may further comprise determining the event log.

The method may further comprise outputting the power log to a user (not shown in FIG. 8). Where the power log is output to a user, said creating of the power log at 1003 may be part of rendering the output. E.g., a graphical view as disclosed with reference to FIG. 5 may be output to the user. Alternatively or additionally, a text representation of the power log may be output.

E.g., said outputting to a user may include interaction with a user. E.g., a user may be able to set breakpoints which halt execution of the software code if a certain, predefined condition is met. E.g., the breakpoints can correspond to the power consumption 131 exceeding a certain threshold power consumption; execution of a certain application and/or machine event 401-404; or a logical combination thereof. Breakpoints can comprise multiple triggers that can be combined by logical operations, e.g., voltage being below a certain predefined threshold and current being above a certain predefined threshold, etc. By means of the breakpoints it is possible to shed light on the cause for an increased power consumption. By providing breakpoints as illustrated above, it becomes possible to implement power-consumption debugging by implementing stepping through the software code to identify blocks of software code causing a comparably high power consumption 131. In this regard, known techniques of debugging can be implemented.

Said outputting to a user can also comprise filter operations; e.g., the power log 500 may be a filter for certain specific types of events 401-404, the power consumption 131 lying within a predefined range or equaling a predefined value, limiting the information output to a user to certain devices 110, 110A, 110B, 110C, etc.

By techniques of outputting the power log 500 as disclosed above, it is possible to present multiple views of the power log 500 based on one and the same flow of events 401-404. In particular, the multiple views may focus on different devices 110, 110A, 110B, 110C for which the power log is created.

Summarizing, above techniques of creating a power log have been illustrated. The power log is created for the power consumption caused by execution of software code by one or more devices. It is possible to combine the power consumption of a plurality of devices into a single power log based on the use of a global timing reference. Thereby, alignment between the execution of software code by different devices is facilitated which enables a reflection of a certain event flow simultaneously from different perspectives. In particular, where execution of software code by inter-related devices such as receivers/transmitters is logged by means of the power log, a powerful tool to reduce the overall power consumption is achieved.

To reference the power consumption and the execution of the software code to the global timing reference, it can be required to synchronize a device-specific local timing reference with the global timing reference. Synchronization of local timing references that may be associated with the power consumption of the various devices and/or the executing of the software code can be performed based on identification of characteristic events that are associated with a zero timestamp, and/or based manual tuning via an HMI.

The outputting of the event log to a user can enable cross-linking events associated with the first device to events associated with the second device, based on the use of the global timing reference. Breakpoints can be implemented based on one or more predefined criteria that may be combined based on logical operations.

Although the invention has been explained with respect to certain preferred embodiments, the scope is only limited by the appended claims.

E.g., while reference has been made to a terminal attached to a wireless network via a radio link and a corresponding access node, in other examples, the power log can be created for different kinds and types of devices. E.g., in some examples, the terminal/access node devices may be implemented according to the Third Generation Partnership Project (3GPP) Long Term Evolution (LTE) protocol and thus may implement a user equipment (UE) evolved Node B (eNB) system. In other examples, the terminal/access node may operate according to the IEEE 802.11x protocol and may implement a station (STA) and access point (AP) Wireless Local Area Network (WLAN) system. Other technologies include Bluetooth, Thread/ZigBee technology in home networks and also Internet-connected devices such as servers and clients.

1. A method, comprising:
receiving indicators of a global timing reference,
receiving indicators of a time-resolved power consumption of a device executing software code, and
referencing the execution of the software code and the power consumption
to the global timing reference when creating a power log.

2. The method of claim 1, further comprising:
receiving indicators of at least one further time-resolved power consumption of at least one further device executing at least one further software code,
referencing the execution of the software code, the power consumption, the execution of the at least one further software code, and the at least one further power consumption to the global timing reference when creating the power log.

3. The method of claim 2,
wherein the device is a terminal attached to a wireless network via an access node of the wireless network, wherein the at least one further device is the access node.

4. The method of claim 1,
wherein the global timing reference is a real time clock.

5. The method of claim 1,
wherein the global timing reference is received according to the Network Time Protocol or the Precision Time Protocol.

6. The method of claim 1,
wherein said referencing is based on a zero timestamp and incremental time intervals relative to the zero timestamp.

7. The method of claim 1,
wherein said referencing is based on a local timing reference of the device.

8. The method of claim 1, further comprising:
receiving an event log of the execution of the software code,
referencing the event log of the execution of the software code and the power consumption to the global timing reference when creating the power log.

9. The method of claim 8,
wherein the event log comprises application events of an application implemented by the software code.

10. The method of claim 8,
wherein the event log comprises machine events of at least one processor of the device executing the soft-ware code.

11. The method of claim 8,
wherein the event log comprises timestamps of a local timing reference of the device.

12. The method of claim 8,
wherein the event log is received via a communication protocol implementing a sequence of incremental transmission time intervals.

13. The method of claim 1,
wherein the software code is a multi-core and/or multi-thread software code.

14. An entity, comprising:
a memory configured to store program code executable by at least one processor,
the at least one processor coupled with the memory and configured to perform the following steps upon execution of the program code:
receiving indicators of a global timing reference,
receiving indicators of a time-resolved power consumption of a device executing software code,
referencing the execution of the software code and the power consumption to the global timing reference when creating a power log.

15. (canceled)
